(19) United States
(12) Patent Application Publication
(10) Pub. No.: US 2007/0110962 A1
(43) Pub. Date: May 17, 2007

(54) Three-dimensional gels that have microscale features

(76) Inventors: Joe Tien, Brookline, MA (US); Min Tang, Allston, MA (US); Andrew P. Golden, Allston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/572,987

(22) PCT Filed: Sep. 23, 2004
(86) PCT No.: PCT/US04/31177

§ 371 Date: Mar. 23, 2006

Related U.S. Application Data
(60) Provisional application No. 60/505,155, filed on Sep. 23, 2003.
(60) Provisional application No. 60/592,717, filed on Jul. 30, 2004.

(51) Int. Cl. B32B 3/00

(52) U.S. Cl. 428/156; 428/172

(57) ABSTRACT

The present invention provides three-dimensional hydrogel structures patterned by a treated micropattern mold. The treated mold is capable of transferring the inverse of its micropattern to a hydrogel by contact during formation or polymerization of the structure from a precursor. The treated micropattern mold surface allows the mold to be separated from the hydrogel without collapsing the structure or irreparably damaging its micropattern. The transferred micropattern may yield individual features and/or interconnected channels in the hydrogel. The invention also provides a hydrogel network fabricated by interfacing at least two hydrogels in which one or more of the hydrogels may be a micropatterned structure. Micropatterned hydrogel structures can also be specifically aligned to interconnect their patterns. Structures or networks of the invention comprise hydrogels that can adhere together by chemically bonding and/or mechanically entangling.

### CROSS REFERENCE TO RELATED APPLICATIONS

This application claims the priority of U.S. Provisional Application No. 60/505,155, filed Sep. 23, 2003, entitled METHODS TO MOLD THREE-DIMENSIONAL MICROSTRUCTURES OF GELS, and 60/592,717 filed on Jul. 30, 2004, entitled THREE-DIMENSIONAL GEL MICROSTRUCTURES, both of which are hereby incorporated by reference herein.

### BACKGROUND OF THE INVENTION

The field of microfabrication generally concerns the manufacture and use of structures with dimensions on the order of micrometers to millimeters. The ability to make structures with micrometer resolution offers significant potential for applications in bioengineering and medicine, especially in tissue engineering. For example, in vitro models of vascular or other biological tissues can be developed based on such structures. Other applications of microfabricated structures or networks include their use as artificial tissues, medical devices, biosensors, drug delivery models or matrices for separations.

Hydrogels have garnered considerable interest as the chemical constituent of microstructures for biological applications. A hydrogel is a three-dimensional polymer, or array of polymers, that is hydrated by water or an aqueous solution. Tanaka, “Gels,” Sci. Am., 244, 124-138 (1981). Typical polymers that comprise hydrogels include proteins and/or sugars. Protein- or sugar-based hydrogels may exhibit properties that resemble those of various biological materials including extracellular matrices, particularly when the protein or sugar is a naturally occurring biological macromolecule.

The microfabrication of structures to date has primarily focused on non-hydrated materials, such as metals, ceramics and hard polymers, instead of hydrogels. These types of microstructures do not contain water as-fabricated. These structures are usually manufactured by pattern transfer methods such as photolithography using light or soft lithography using a micropatterned mold. In soft lithography, the surface of the mold contains a micropatterned topology. Xia et al., “Soft lithography,” Angew. Chem. Int. Ed., 37, 551-575 (1998). The inverse of this micropatterned topology is transferred to the structure during, for example, microtransfer molding, micromolding in capillaries or replica molding. Although polymeric and metal structures are convenient to fabricate by either photolithography or soft lithography, these microstructures poorly represent in vitro models of vascular or other biological tissues. These structures are also generally incapable of encapsulating a suspension of biological materials.

Pattern transfer methods have also been used to fabricate protein or cell layers on a micropatterned mold such as, for example, poly(dimethylsiloxane) (PDMS). Borenstein et al., “Microfabrication technology for vascularized tissue engineering,” Biomed. Microdevices, 4, 167-175 (2002). Although these layers consist of biological materials, they are too thin to represent in vitro models of three-dimensional biological gels or extracellular matrices. In addition, protein and cell layers are too thin to support a suspension of biological materials. These layers also cannot be interconnected or bonded together to yield more complex structures, such as a three-dimensional network.

Although bulk hydrogels of various compositions have been developed for many applications such as electrophoresis and chromatography, patterned microstructures or networks that have microscale inner and outer surface geometries cannot be easily fabricated in hydrogels. Photopolymerization of monomer and macromer solutions are suitable for forming simple hydrogel structures. Beebe et al., “Functional hydrogel structures for autonomous flow control inside microfluidic channels,” Nature, 404, 588-590 (2000). These methods, however, cannot consistently and accurately manufacture complicated hydrogel structures with a micropatterned surface topology. Moreover, these methods are poorly suited for fabricating hydrogels that consist of materials that cannot be photopolymerized, such as collagen, proteoglycans or living cells. A photopolymerization method is also not developed for manufacturing three-dimensional hydrogels that have open network topologies.

Methods based on cellular self-assembly have related shortcomings to those described above for fabricating micropatterned hydrogel structures. Cellular self-assembly involves interactions among cells and extracellular matrices that work to naturally form a microarray. Jakab et al., “Engineering biological structures of prescribed shape using self-assembling multicellular systems,” Proc. Natl. Acad. Sci. USA, 101, 2864-2869 (2004). Histogenesis and/or organogenesis are examples of such methods. Self-assembly is inconvenient for fabricating hydrogel structures comprising a suspension of biological materials or those that are networked together.

Based on the limitation of the methods described above, a need exists for a method to manufacture three-dimensional hydrogels that have microscale features. There is also a need for microfabricating hydrogels that can be interconnected to yield a network that can, for example, represent in vitro models of vascular or other biological tissues. A need also exists for bonding hydrogel structures together to yield more complex three-dimensional structures. There is also a need for hydrogel structures and networks that can support a suspension of biological or other materials.

### SUMMARY OF THE INVENTION

The present invention provides three-dimensional hydrogel structures patterned by a treated micropatterned mold. The treated mold is capable of transferring the inverse of its micropattern to a hydrogel by contact during formation or polymerization of the hydrogel from a precursor. The surface treatment of the micropatterned mold is designed to eliminate nonspecific binding between the hydrogel and mold. The hydrogel and mold can be separated from each other without collapsing the structure of the hydrogel or irreparably damaging its micropattern. The micropattern that is transferred may yield individual and/or interconnected features such as, for example, channels in the hydrogel that can sustain the flow of liquids. A hydrogel structure of the invention comprises a polymer array surrounded by a fluid, such as, for example, water or an aqueous solution, that hydrates the array.

The hydrogel precursor may be supported by a substrate, such as, for example, glass or a polystyrene dish, when it is contacted by the micropatterned mold. The substrate may also support the formed or polymerized hydrogel structure during and/or after patterning and separation from the mold. Alternatively, a hydrogel precursor can be formed or polymerized on top of the micropatterned mold. The polymer array of a micropatterned hydrogel structure may, for example, be protein and/or sugar-based. Such hydrogel structures can be embedded with biological, organic, metallic, and/or inorganic materials, such as drugs, macromolecules, micro- or nanoparticles, or cells.

The hydrogel structures of the invention can also be formed or polymerized to encapsulate other hydrogels of the same or different type. An encapsulated hydrogel that is a different type may be perturbed, for example, by an enzyme that specifically digests the encapsulated hydrogel, to form cavities in the encapsulating structure. These cavities can be micropatterned provided that the perturbed hydrogel was micropatterned. Hydrogel structures can also be interfaced with other hydrogels to yield more complicated structures. For example, a first hydrogel structure can be bonded or entangled with a second hydrogel structure.

The invention also provides a hydrogel network fabricated by interfacing at least two hydrogels in which one or more of the hydrogels may be a micropatterned structure. The hydrogel structures of a network may be patterned by a treated micropatterned mold such as described above. For example, the mold may transfer the inverse of its micropattern to one or more of the hydrogel structures. The micropattern that is transferred may yield individual features and/or interconnected channels in the hydrogel that are operable for microfluidic flow. Micropatterned hydrogel structures can also be specifically aligned to interconnect their patterns. These interconnected micropatterns can comprise a microfluidic network. Similarly, a micropatterned hydrogel structure featuring channels may be flushly contacted by a material, for example, a petri dish, such that the hydrogel and material form a microfluidic network. The interfaced hydrogels may also be combined into a multilayer structure.

Structures or networks of the invention comprise hydrogels that can adhere together by chemically bonding and/or mechanically entangling. The structures or networks may also not be adhered together. This bonding and/or entanglement can be facilitated by exposing the hydrogels to a controlled concentration of destabilizers at the area of interface. The diffusion of one or more hydrogel precursors into a hydrogel structure or network and then forming or polymerizing the precursors can also be used to bond and/or entangle hydrogels together. Hydrogel structures or networks can also be supported by one or more substrates such as, for example, glass or a polystyrene wafer. The invention also provides stabilizers, often kosmotropes, and destabilizers, often chaotropes, that can be used to affect the conformation of the hydrogels and facilitate bonding and/or entanglement. A hydrogel structure or network of the invention can be used to represent models of in vitro vascular or other biological tissues.

A treated micropatterned mold used to pattern one or more hydrogels can be a poly(dimethylsiloxane) (PDMS) mold. As described above, hydrogel precursors can be formed or polymerized while in contact with the treated surface of a micropatterned mold, such that the mold transfers the inverse of its pattern to the hydrogel structure. This pattern transfer can be accomplished by methods that include, for example, microtransfer molding, micromalding in capillaries and replica molding. These methods may involve the hydrogels being formed or polymerized while in contact with a substrate. These methods can allow individual and/or interconnected features, such as, for example, channels, to micropattern a hydrogel structure with a repeatable resolution that is less than about 5 μm. This resolution corresponds to the size of the features on the surface of the treated micropatterned mold.

The micropatterned surface of the mold is treated prior to contact with the hydrogel precursor, in order for the formed or polymerized structure to be separated from the mold without collapsing or irreparably deforming the micropattern on the hydrogel. The micropatterned mold can be treated by a release agent absorbed or layered on the surface of the mold. These release agents include, for example, bovine serum albumin (BSA), immunoglobulins, copolymers of ethylene oxide and propylene oxide, and/or oligo(ethylene glycol)-terminated self-assembled monolayers. The release agents can also be used to treat a substrate, such as, for example, glass or a polystyrene wafer. The type of release agent used can depend on the composition of the micropatterned mold or substrate being treated.

The invention provides a convenient method for fabricating the hydrogel structures and networks described above. For example, the invention provides a method for fabricating a micropatterned hydrogel structure by using a treated micropatterned mold. The method is capable of reproducibly transferring the inverse of the micropattern of the mold to a hydrogel structure at a resolution that is less than about 5 μm. A method of the invention generally comprises forming or polymerizing a hydrogel precursor while the precursor is in contact with the treated surface of the micropatterned mold. The method can also comprise the micropatterned hydrogel being formed or polymerized on a substrate. The micropatterned hydrogel can be separated from the mold, without being collapsed or irreparably deformed, by any suitable process. These processes include, for example, vibration, mechanical separation, application of air bubbles or application of buoyant forces from a fluid acting on the mold.

The method of the invention can be used to embed and/or suspend biological, organic, metallic, and/or inorganic materials within a hydrogel structure. The present method can also be used to interface a plurality of hydrogel structures. This interfacing may allow the structures to be combined into a microfluidic network or a multilayered structure. The interfacing may also comprise bonding and/or entangling hydrogels into a more complex structure or network. According to the invention, this bonding and/or entanglement can be aided by destabilizers acting alone, or with a stabilizer to conform the polymer array of a hydrogel. The diffusion of one or more hydrogel precursors into a hydrogel structure or network and then forming or polymerizing the precursors can also be used to bond and/or entangle the hydrogels. The method also describes the formation of a hydrogel structure that encapsulates other hydrogels of a different formulation. An encapsulated hydrogel that is a different type may be perturbed, for example, by an enzyme that specifically digests the encapsulated hydrogel, to form cavities in the encapsulating structure. These cavities can be micropatterned provided that the perturbed hydrogel was micropatterned.

### DESCRIPTION OF THE DRAWINGS

Other features and advantages of the present invention will be apparent from the following detailed description of the invention, taken in conjunction with the accompanying drawings of which:

FIG. 1 is a representation of a scheme for fabricating a micropatterned collagen-based hydrogel structure of the invention by a replica molding method, the hydrogel structure formed or polymerized while in contact with a treated micropatterned mold and supported by a substrate;

FIG. 2 is an optical micrograph of a micropatterned collagen-based hydrogel structure supported on a glass substrate fabricated according to the scheme in FIG. 1;

FIG. 3 is a representation of a scheme for fabricating a micropatterned collagen-based hydrogel structure of the invention by a microtransfer molding method, the hydrogel structure formed or polymerized while in contact with a treated micropatterned mold and supported by a substrate;

FIG. 4 i s an optical micrograph of a micropatterned collagen-based hydrogel structures fabricated according to the scheme in FIG. 3 and supported on a glass substrate, or released into solution as a suspension as shown in the inset micrograph;

FIG. 5 is a representation of a scheme for fabricating a micropatterned collagen-based hydrogel structure of the invention by a micromolding in capillaries method, the hydrogel structure formed or polymerized while in contact with a treated micropatterned mold and supported by a substrate;

FIG. 6 i s an optical micrograph of a micropatterned collagen-based hydrogel structure supported on a glass substrate fabricated according to the scheme in FIG. 5;

FIG. 7 is a representation of a scheme for interfacing a micropatterned hydrogel structure supported on a substrate with a collagen-based precursor during its formation or polymerization into a hydrogel, the interfacing being aided by treated glass which contacts both hydrogels, the hydrogels of the invention each comprising a suspension of cells;

FIG. 8 includes optical micrographs of the hydrogels of the invention, the micrographs showing the micropatterned hydrogel structure prior to being interfaced with the collagen-based precursor and after formation or polymerization of the precursor into a hydrogel according to the scheme in FIG. 7;

FIG. 9 is a representation of a scheme for interfacing a first and second micropatterned hydrogel structure each supported on a separate substrate, the first and second hydrogels of the invention each comprising a suspension of cells;

FIG. 10 includes optical micrographs of the hydrogels of the invention, the micrographs showing the first micropatterned hydrogel structure before and after interfacing with the second micropatterned hydrogel structure according to the scheme in FIG. 9, the micrographs also showing the second hydrogel stacked on the first;

FIG. 11 is a representation of a scheme for interfacing a micropatterned MATRIGEL-based (Becton, Dickinson and Company, 2350 Qume Drive, San Jose, Calif. 95131) hydrogel structure supported on a micropatterned mold and a substrate-supported collagen-based hydrogel, the scheme showing the MATRIGEL-based hydrogel encapsulated by the collagen-based hydrogel, and the MATRIGEL-based hydrogel digested by the enzyme dispase to form cavities in the encapsulating collagen-based hydrogel structure;

FIG. 12 includes optical micrographs of the hydrogels of the invention, the micrographs showing the MATRIGEL-based hydrogel encapsulated in the collagen-based hydrogel, and the collagen-based hydrogel with cavities formed by the digestion of the MATRIGEL-based hydrogel according to the scheme in FIG. 11, the micrographs also showing the MATRIGEL-based hydrogel encapsulated in the collagen-based hydrogel with iron particles in the MATRIGEL-based hydrogel, and the collagen-based hydrogel after a tilted enzyme digestion of the MATRIGEL-based hydrogel, the collagen-based hydrogel structure comprising cavities partially filled with undigested iron particles from the MATRIGEL-based hydrogel, which indicate the direction of tilt;

FIG. 13 includes optical micrographs of a collagen-based hydrogel structure comprising endothelial cells in the cavities of the structure;

FIG. 14 is a representation of a scheme in which a micropatterned MATRIGEL-based hydrogel is encapsulated in a micropatterned collagen-based hydrogel, with both hydrogels supported on a substrate and secured by poly(dimethylsiloxane) (PDMS) members, the hydrogels tilted as dispase enzyme in a phosphate buffered saline (PBS) solution digests the MATRIGEL-based hydrogel, forms cavities in the encapsulating collagen-based hydrogel and flows through the cavities formed in the structure;

FIG. 15 includes optical micrographs of the hydrogels of the invention, the micrographs showing formed cavities in the collagen-based hydrogel structure with dispase enzyme in a PBS solution flowing through the cavities over the course of six hours according to the scheme in FIG. 13, the micrographs also showing formed cavities in the collagen-based hydrogel structure without dispase enzyme in a PBS solution flowing through the cavities over the course of six hours;

FIG. 16 is a representation of a scheme for interfacing a micropatterned hydrogel supported on a first substrate and an unpatterned hydrogel supported on a second substrate, the scheme showing a relative concentration of destabilizers controlled so as to affect conformation of either hydrogel and bond and/or entangle the hydrogels prior to separation of the first substrate;

FIG. 17 is an optical micrograph of a micropatterned collagen-based hydrogel structure of the invention supported on a substrate with a cell suspension flowed into the structure; and

FIG. 18 is an optical micrograph of a micropatterned hydrogel structure of the invention supported on a substrate with a cell suspension flowed into the structure.

### DETAILED DESCRIPTION OF THE INVENTION

The present invention provides three-dimensional hydrogel structures and networks patterned by a treated micropatterned mold. The structures or networks of the invention can be used, for example, to represent in vitro models of vascular or other biological tissues. The treated mold is capable of transferring the inverse of its micropattern to a hydrogel by contact during formation or polymerization of the structure from a precursor. The micropattern that is transferred may yield individual and/or interconnected features such as, for example, channels in the hydrogel that are operable for microfluidic flow. The micropatterned features of the hydrogel structures can have a resolution that is less than about 5 μm.

The micropatterned hydrogel structures of the invention can also be interfaced so as to adhere together by chemically bonding and/or mechanically entangling. The diffusion of one or more hydrogel precursors into a hydrogel structure or network and then forming or polymerizing the precursors can also be used to bond and/or entangle the hydrogels. A network of hydrogels may also be fabricated by interfacing individual hydrogel structures. Micropatterned hydrogel structures can also be specifically aligned to interconnect their patterns. These interconnected micropatterns can comprise a microfluidic network. A hydrogel structure or network of the invention can be used, for example, as a component of artificial tissues, medical devices, biosensors, drug delivery models or separation processes.

Hydrogel structures are patterned by a treated micropatterned mold that contacts the precursor of the hydrogel during formation or polymerization. The transferred micropattern is the inverse of the pattern on the treated surface of the mold. The transferred micropattern defines the surface topology of the fabricated hydrogel structure. The treated micropatterned molds can, for example, be poly(dimethylsiloxane) (PDMS) molds, silicon wafers patterned with crosslinked photoresist or glass. The micropattern of the mold can be transferred by methods that include, for example, microtransfer molding, micromolding in capillaries and replica molding. The surface of a micropatterned mold employed in these methods is treated with a release agent, which is absorbed or layered on the mold. These release agents include, for example, bovine serum albumin (BSA), immunoglobulins, copolymers of ethylene oxide and propylene oxide, and/or oligo(ethylene glycol)-terminated self-assembled monolayers.

These release agents may prevent or substantially minimize nonspecific binding between the micropatterned mold and the hydrogel precursor and the resulting hydrogel structure. The release agent that is selected to treat the micropatterned mold surface can also depend on the composition of the mold. A BSA solution, for example, may be used to treat a PDMS micropatterned mold. This solution may contain about one percent by weight of BSA in a phosphate buffered saline (PBS) solution. The BSA solution can be applied to the micropatterned mold at about 4° C. for about an hour or more. The solution that is not absorbed onto the surface of the mold can be rinsed away, if desired. A treated micropatterned mold can be separated from the hydrogel without collapsing the structure or irreparably deforming the micropattern on the hydrogel. The concentrations, temperatures and/or times identified above are provided merely as examples as any other suitable ranges of the same could be used according to the invention.

The treated mold can be separated from the micropatterned hydrogel structure by methods that include, for example, vibration, mechanical separation, application of air bubbles or application of buoyant forces from a fluid acting on the mold. A pneumatic or chemical separation of the micropatterned mold is also suitable in some embodiments. As an example, a PDMS micropatterned mold can be separated by application of buoyant forces from a fluid acting on the mold. In this separation method, PBS, a hydrophilic solution, may be applied around the PDMS mold, which is hydrophobic. The buoyant forces on the mold separate the mold from the hydrogel structure. It can also be useful to moisten the micropatterned mold surface prior to application of the release agent so as to reduce surface energy and prevent air babbles. The micropatterned mold may be moistened, for example, by a solvent, aqueous solution or alcohol, such as, ethanol.

A hydrogel structure of the invention comprises an interconnected array of polymers surrounded by a fluid that hydrates the array. The fluid may also comprise, for example, solvated particles such as ions and/or salts. The fluid acts in equilibrium with the polymer array and ions and/or salts that may be present, to help support the integrity of the hydrogel such that it does not collapse or deform. The present hydrogels may, for example, be protein and/or sugar-based. These hydrogels can be useful for embedding and/or suspending biological, organic, metallic, or inorganic materials, such as drugs, macromolecules, or cells, in the hydrogel structure. These hydrogel structures can also be supported by a substrate such as, for example, glass or a polystyrene wafer.

The hydrogel structures of the invention can also be formed or polymerized to encapsulate other hydrogels of the same or a different type. An encapsulated hydrogel that is a different type may be perturbed, for example, by an enzyme that specifically digests the encapsulated hydrogel, to form cavities in the encapsulating structure. These cavities can be micropatterned provided that the perturbed hydrogel was micropatterned. Hydrogel structures can also be interfaced with other hydrogels to yield more complicated structures. For example, a first hydrogel structure can be bonded or entangled with a second hydrogel structure.

In one embodiment, a three-dimensional hydrogel structure is micropatterned by contact with the surface of a treated micropatterned mold during formation or polymerization of a hydrogel precursor. This embodiment employs pattern transfer methods that include, for example, microtransfer molding, micromolding in capillaries or replica molding. The micropatterned hydrogel structure is capable of maintaining its integrity for an extended length of time that can include at least several months. The hydrogel generally comprises a polymer array of material surrounded by a fluid, such as, for example, water or an aqueous solution. The fluid hydrates the hydrogel and helps maintain the three-dimensional structure along with the polymer array and any solvated ions and/or salts that may also be present. The hydrogel structures may be protein and/or sugar-based. Examples of protein and/or sugar-based hydrogels include those that comprise an array of collagen, MATRIGEL, gelatin, agarose or combinations of these proteins and/or salts. As described above, these hydrogels can be formed or polymerized from a hydrogel precursor. The precursor may be prepared by any suitable method, which can depend on the composition of the hydrogel.

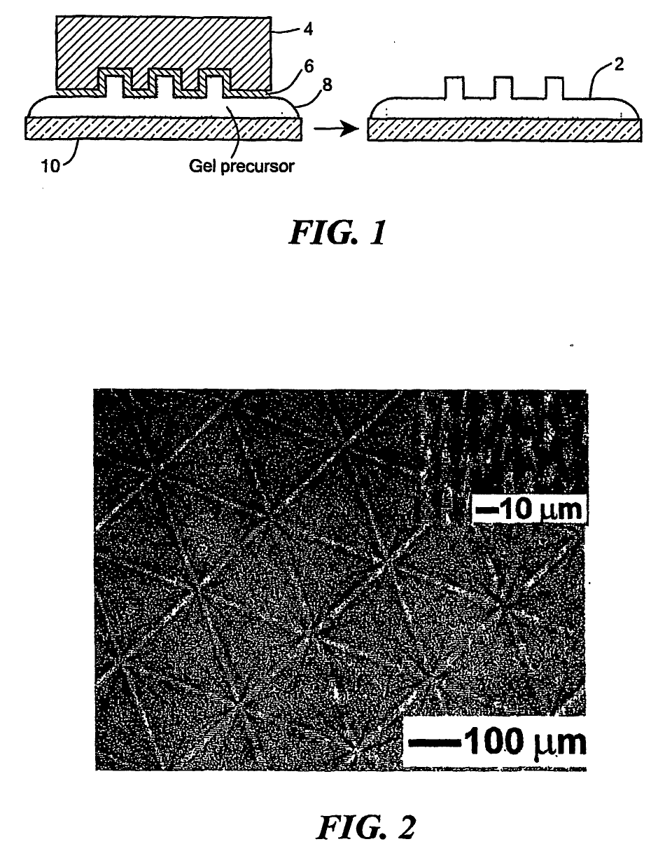

FIG. 1 is a representation of a scheme for fabricating a micropatterned hydrogel structure 2 employing a replica molding method and a micropatterned mold 4. As described above, the mold is preferably treated with a release agent 6. The scheme comprises a collagen-based hydrogel precursor 8 dispersed onto a substrate 10. For the hydrogel precursor, components and/or subunits of collagen polymers, for example, can be dissolved in a solution of acetic acid. This solution may then be neutralized at 4° C. with sodium hydroxide and by adding 10 times the concentration of a PBS solution such, that the overall solution has a favorable osmolarity for cells. The concentrations, temperatures and/or types of solutions identified above are provided merely as examples as any other suitable ranges or types of the same could be used according to the invention.

A hydrogel precursor can be formed or polymerized by a variety of methods. These methods can include, for example, photopolymerization, free radical polymerization, cationic polymerization or anionic polymerization. The formation and polymerization of a hydrogel structure can be influenced by parameters that include temperature, humidity, total ionic concentration, concentration of particular ions, time and pH. A suitable method for collagen-based hydrogel polymerization, for example, involves neutralizing the collagen-based precursor at about 4° C. such that polymerization occurs after the temperature is changed, for example, to about 37° C. The formation or polymerization of the precursor into a hydrogel is performed as the hydrogel precursor is contacted by the surface of the treated micropatterned mold. The temperatures identified above are provided merely as examples as any other suitable ranges of the same could be used according to the invention.

The treated micropatterned mold 4 in FIG. 1 transfers the inverse of its pattern to the hydrogel by a replica molding method. This method involves heating the forming or polymerizing hydrogel precursor and micropatterned mold at about 37° C. in an incubator operating under a saturated relative humidity. This incubator heating can be performed for about one hour. The treated micropatterned mold is then separated from the hydrogel without collapsing the structure or irreparably deforming the micropattern. As shown, the structure is supported on a suitable substrate. Such substrates include, for example, biological, organic, metal, inorganic or synthetic wafers, glass or other hydrogels. The temperatures and times identified above are provided merely as examples as any other suitable ranges of the same could be used according to the invention.

The topology of the hydrogel structure may be micropatterned as individual and/or interconnected features. These features and/or channels can have a repeatable resolution that is less than about 5 μm. The interconnected channels can also be operable for microfluidic flow. The hydrogel structure may also be separated from the substrate in an embodiment of the invention and/or can be suspended in a solution. FIG. 2 is an optical micrograph of one of a variety of micropatterned collagen-based hydrogel structures fabricated according to the scheme in FIG. 1. This micropatterned structure is supported on a glass substrate. The micrograph shows a representative micropattern on the surface of the structure. The collagen-based hydrogel may be micropatterned to substantially cover the entire surface of the substrate.

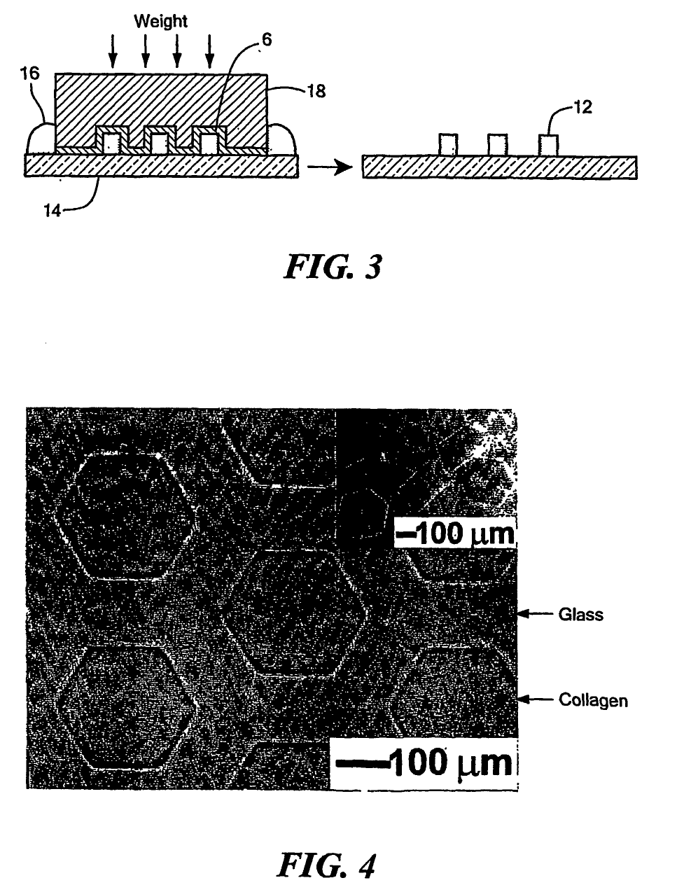

An alternate scheme for micropatterning a hydrogel structure involves a microtransfer molding method. This scheme is represented in FIG. 3 in which a collagen-based hydrogel 12 is fabricated and supported by a glass substrate 14. Although not shown, microtransfer molding may also be used to fabricate hydrogel structures that are interfaced into a network. In FIG. 3, a precursor 16 is disposed on the substrate. The precursor is formed or polymerized as it is contacted by the treated surface of a micropatterned mold 18. As described above, the surface of the mold is preferably treated with a release agent 6. Also described above, the treated mold transfers the inverse of its pattern to the forming or polymerizing hydrogel. Microtransfer molding can also be used to fabricate individual and/or interconnected micropatterned features.

The pattern transferred from the micropatterned mold to the hydrogel may be aided by pressure applied to the mold by a suitable weight. The weight used for micropatterning is dependent on, for example, the type of hydrogel and the surface area of the pattern. By adding a sufficient amount of pressure, the hydrogel structure may be micropatterned with holes so that, for example, an interconnection of channels can be fabricated between multiple bonded and/or entangled hydrogel structures. The release agent may be absorbed or layered on the mold. These release agents include, for example, bovine serum albumin (BSA), immunoglobulins, copolymers of ethylene oxide and propylene oxide, and/or oligo(ethylene glycol)-terminated self-assembled monolayers.

The release agent allows the micropatterned mold to be separated from the hydrogel without collapsing or irreparably deforming the structure or its micropattern. As shown, the topology of the hydrogel structure is micropatterned such that its features correspond to the inverse of those for the treated micropatterned mold. The features of FIG. 3 can have a resolution that is less than about 5 μm. A typical micropatterned hydrogel structure prepared by this scheme and supported on a glass substrate is shown in the optical micrograph of FIG. 4. The optical micrograph shows a collagen-based hydrogel structure with a representative micropattern on the surface of the structure. The hydrogel is micropatterned to partially expose the supporting glass substrate. The hydrogels of the invention can also comprise a suspension of biological materials, drugs, organics, metals, inorganics, macromolecules, cells or synthetic materials.

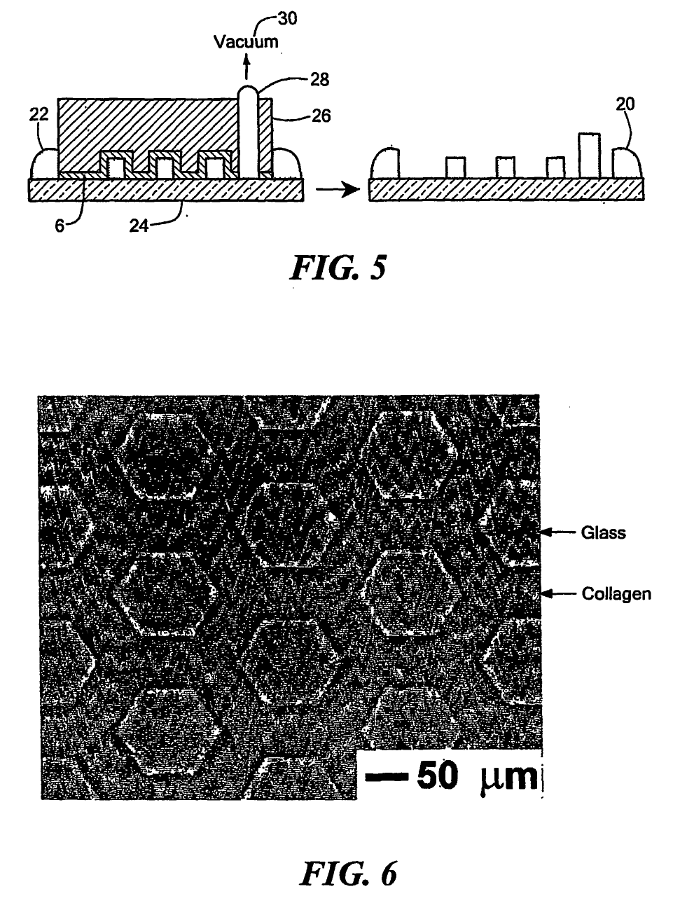

FIG. 5 is a representation of a scheme for fabricating another hydrogel structure 20 that is micropatterned. The scheme comprises a collagen-based hydrogel precursor 22 dispersed on a glass substrate 24. The treated micropatterned mold 26 transfers the inverse of its pattern to the hydrogel structure by a micromolding in capillaries method. This method can be used to fabricate individual and/or interconnected features in the topology of the hydrogel. The method involves a seal formed by the substrate and the micropatterned mold that preferably allows vacuum pressure to draw, in one embodiment, a moistening solution into channels 28 within the mold. The moistening solution can, for example, be ethanol that is present between the substrate and micropatterned mold.

After the channels of the mold are moistened, a release agent 6, such as, for example, BSA, can be vacuum drawn by a device 30 through the channels to completely treat the micropatterned mold. As described above, treatment of the mold prevents or substantially minimizes nonspecific binding between the mold and the hydrogel precursor and the resulting hydrogel structure. With the mold and its channels treated, vacuum pressure is again provided to draw the precursor into the channels of the micropatterned mold. The hydrogel precursor is then formed or polymerized into the micropatterned hydrogel structure.

The treated surface of the micropatterned mold can pattern the hydrogel structure while it is in contact with the substrate. The micropattern that is transferred may yield individual and/or interconnected features such as, for example, channels in the hydrogel that are operable for microfluidic flow. The micropatterned features of the hydrogel structure can have al resolution that is less than about 5 μm. A typical micropatterned hydrogel structure prepared by this scheme and supported on a glass substrate is shown in the optical micrograph of FIG. 6. The optical micrograph shows a collagen-based hydrogel structure with a representative micropattern on the surface of the structure. The hydrogel is micropatterned to partially expose the supporting glass substrate.

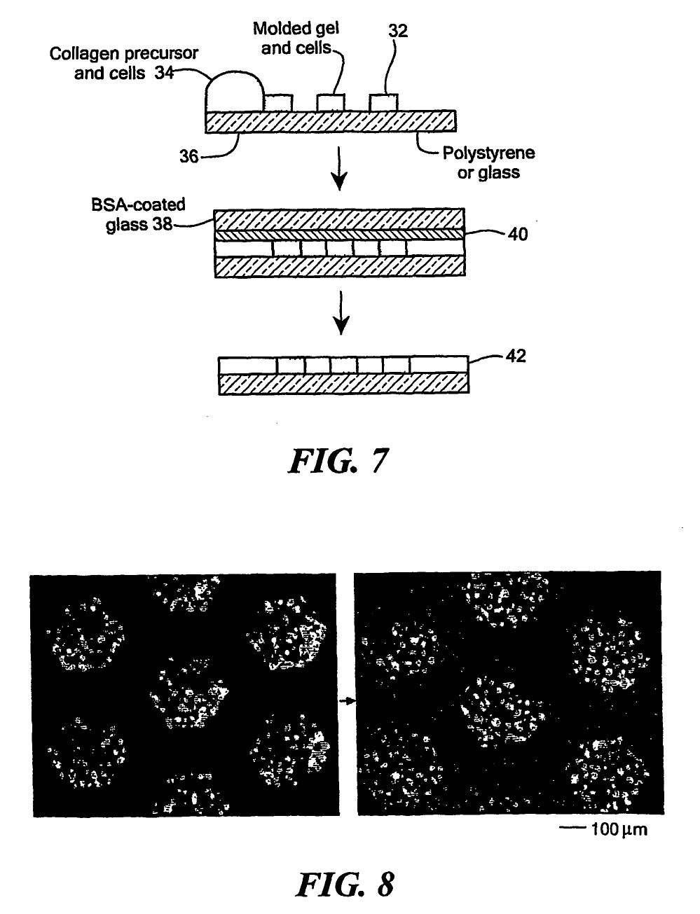

In another embodiment, the micropatterned hydrogel structures described above can be interfaced with other hydrogels to yield more complicated structures. For example, FIG. 7 is a scheme for interfacing a micropatterned hydrogel structure 32 with a collagen-based precursor 34 that is formed or polymerized into a hydrogel while surrounding the structure in a two-dimensional plane. The micropatterned hydrogel can be supported on, for example, a glass substrate 36. The micropatterned hydrogel structure, here as elsewhere, may be protein and/or sugar-based. Examples of protein and/or sugar-based hydrogels include those that comprise an array of collagen, MATRIGEL, gelatin, agarose or combinations of these proteins and/or salts.

The precursor 34 in this scheme and the precursor of the formed or polymerized micropatterned hydrogel 32 may be mixed with a suspension of biological materials, drugs, organics, metals, inorganics, macromolecules, cells or synthetic materials. The suspension can also comprise any combination of such materials. A suspension of fibroblasts and/or endothelial cells, for example, may be prepared in a media by growing cells on a substrate, and providing trypsin to allow the cells to be introduced into solution. This solution can also be centrifuged to increase the concentration of the cells. In the scheme of FIG. 7, the collagen-based precursor may be mixed with mammalian fibroblast cells, which can be suspended at a density of about 10⁸ cells per milliliter of precursor. This density is provided merely as an example as any other suitable ranges of the same could be used according to the invention.

The scheme also allows for the micropatterned hydrogel structure to comprise a suspension of mammalian fibroblast cells. This suspension may be labeled with a specific fluorescent marker, which can be used to distinguish, for example, the fibroblast cells of the micropatterned hydrogel from those cells suspended in the precursor. The micropatterned structure may also be fabricated by a microtransfer molding method employing a treated micropatterned mold. As described above, microtransfer molding can be used to fabricate individual and/or interconnected micropatterned features such as, for example, channels in the hydrogel that are operable for microfluidic flow. The micropatterned features of the hydrogel structure can have a resolution that is less than about 5 μm.

After mixing the precursor 34 with fibroblast cells and dispersing it to surround the micropatterned hydrogel structure 32, the precursor and hydrogel structure may be contacted by, for example, a glass layer 38 treated with a BSA solution 40. For example, the glass can be treated by an individual droplet of BSA solution containing about 5 μl. The treated glass can aid the interfacing of the precursor and micropatterned hydrogel. The precursor can then disperse by capillary forces into, for example, the channels of the micropattern hydrogel. The precursor is subsequently formed or polymerized with the treated glass in place to yield a hydrogel. The treated glass can also be separated from the hydrogels without collapsing or irreparably deforming the resulting coplanar structure 42. This coplanar structure may comprise two individual sets of fibroblast cells, each suspended within their respective hydrogel.

Optical micrographs in FIG. 8 show a typical micropatterned hydrogel structure comprising a suspension of mammalian fibroblasts cells. The micropatterned hydrogel is first shown before it is interfaced with the collagen-based precursor, which also comprises a suspension of mammalian fibroblast cells. The micropatterned structure has channeled features that are supported on a substrate. After interfacing and formation or polymerization of the precursor, the micrographs show the resulting coplanar structure. This coplanar structure comprises two individual sets of mammalian fibroblast cells, each suspended within their respective hydrogel. These sets of cells are distinguished by different fluorescent markers.

The micropatterned hydrogel structures described above can also be interfaced with other hydrogels. These interfaced hydrogels may yield a multilayered hydrogel structure. The interfaced hydrogels can also adhere together by chemically bonding and/or mechanically entangling. This bonding and/or entanglement also allows hydrogel structures to be combined and fabricated into more complex hydrogel structures. Bonding and/or entanglement can be facilitated by destabilizers acting alone, or with a stabilizer to conform the polymer array of a hydrogel. For example, when a hydrogel is exposed to a controlled concentration of destabilizers, its polymers can change conformation so that they may substantially interact with an interfaced hydrogel.

The hydrogel that is conformed is then stabilized while in contact with the interfaced hydrogel. During stabilization, the polymers of each hydrogel are conjectured to adhere together by chemically bonding and/or mechanically entangling. The degree to which the hydrogels can be bonded and/or entangled together may be manipulated by varying the parameters under which the destabilizer and stabilizer, if any, are used. These parameters can include, for example, temperature, humidity, total ionic concentration, concentration of a destabilizer and/or stabilizer, time and pH. The type of hydrogels that are interfaced together can also affect the degree of chemical bonding and/or mechanical entanglement.

A suitable destabilizer and stabilizer can depend on the composition of the hydrogel's polymer array. In general, these destabilizers and stabilizers can be chaotropes and kosmotropes, respectively. Common destabilizers in water include, for example, SCN⁻, H₂PO₄⁻, guanidinium, HSO₄⁻, HCO₃⁻, urea, I⁻, Cl⁻, NO₃⁻, tetramethylammonium, NH₄⁺, Cs⁺ or K⁺. Examples of stabilizers in water can include SO₄²⁻, HPO₄²⁻, Mg²⁺, Ca²⁺, Li⁺, Na⁺, H⁺, OH⁻ or HPO₄²⁻. More specifically, destabilizers of collagen, MATRIGEL and/or agarose polymers can include, for example, NaSCN, urea, LiCl, glucose, NaClO₄, MgCl₂, glycerol, CON₂H₄ or guanidinium HCl. Stabilizers of collagen polymers can include NaF, NaSO₄, betaine, NH₄Cl or trimethylamine N-oxide. The destabilizers and stabilizers identified above can also be used in combination with each other or different solutions, such as, for example, a PBS solution, to affect the conformation of a particular hydrogel. A hydrogel may also be stabilized by a chaotrope and destabilized by a kosomotrope.

There are several approaches to using destabilizers and stabilizers for chemically bonding and/or mechanically entangling interfaced hydrogels. One approach is to controllably diffuse or flow a destabilizer into a first hydrogel, which is interfaced with a second hydrogel, at a concentration sufficient to change the conformation of the first hydrogel's polymer array. The destabilizers can affect the conformation of the polymers at the area of interface between the hydrogels by diffusing or flowing through the hydrogel structure and/or channels micropatterned on the surface of a hydrogel. A destabilizer may also be applied to the surface of one or both of the hydrogels before they are interfaced.

The destabilizer is conjectured to allow the polymers of the first hydrogel to substantially interact with the interfaced hydrogel, whose polymers may also be affected by the destabilizer. A solution is then introduced, for example, by controlled diffusion or flow, to lower the relative concentration of the destabilizer so that the first hydrogel's polymers stabilize and can chemically bond and/or mechanically entangle with the polymers of the interfaced hydrogel. This solution may, for example, be a PBS solution, which is relatively neutral in terms of destabilizing and/or stabilizing hydrogels.

Another approach is to employ a destabilizer and a stabilizer, which can act together on the polymer array of a hydrogel. In this approach, the concentrations of the stabilizer and destabilizer can be regulated to control the conformation of the hydrogel's polymers. As described above, the destabilizers and stabilizers can affect the conformation of polymers at the area of interface between the hydrogels by diffusing or flowing through the hydrogel structure and/or channels micropatterned on the surface of a hydrogel. The first hydrogel is initially destabilized to affect the conformation of its polymers. The relative concentration of the destabilizer is then lowered by increasing the concentration of the stabilizer so that the first hydrogel stabilizes and can chemically bond and/or mechanically entangle with the polymers of the interfaced hydrogel.

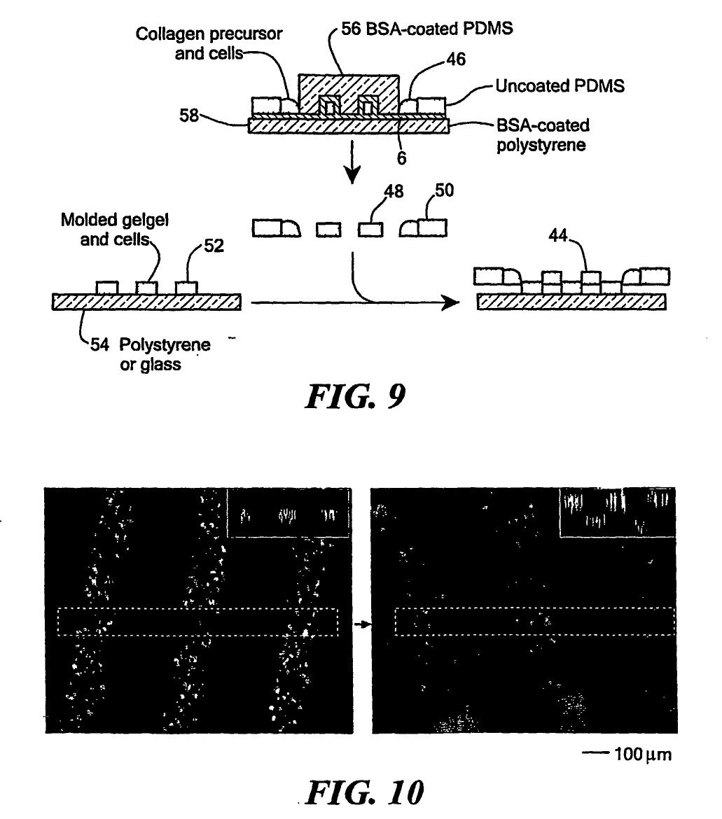

FIG. 9 is a representation of a scheme for fabricating a multilayered micropatterned hydrogel structure 44 of the invention. The scheme comprises interfacing micropatterned hydrogel structures. The hydrogel structures can, for example, be formed or polymerized during a replica molding method. In the scheme, the precursor 46 of a second micropatterned hydrogel 48 may be formed or polymerized while in contact with a PDMS frame 50. The PDMS frame can be untreated such that the formed or polymerized hydrogel nonspecifically binds to the frame. A first micropatterned hydrogel 52 may also be supported on a suitable substrate 54.

After the precursor 46 forms or polymerizes, the treated micropatterned mold 56 and a treated substrate 58 are separated from the second micropatterned hydrogel structure 48. The mold and substrate are preferably treated by a release agent 6. The second structure can remain in contact with the PDMS frame 50. The second hydrogel structure can then be interfaced with the first micropatterned hydrogel structure 52. This interfacing can be aided by immersing the structures in a solution, such as, for example, saline, so that when the solution is removed the hydrogels contact each other. The hydrogels may also be interfaced in a nonbinding manner. When the hydrogels are interfaced, the resulting structure 44 comprises multilayered micropattern hydrogels. This multilayered micropatterned hydrogel structure can be supported on the substrate 54.

The precursors in this scheme can be mixed with a suspension of biological materials, drugs, organics, metals, inorganics, macromolecules, cells or synthetic materials. The suspension can also comprise any combination of such materials. A suspension of fibroblasts and/or endothelial cells, for example, may be prepared in a media by growing cells on a substrate. This solution can also be centrifuged to increase the concentration of the cells. In the scheme of FIG. 9, the collagen-based precursor 46 may be mixed with endothelial cells, which can be suspended at a density of about 108 cells per milliliter of precursor. The first micropatterned hydrogel structure 52 may also comprise a suspension of endothelial cells. By comprising one or more suspensions of cells, the micropatterned multilayered hydrogel structure, 44 may be used, for example, as a scaffold that can be employed to model cellular behavior.

Optical micrographs in FIG. 10 show a typical first micropatterned hydrogel structure comprising a suspension of endothelial cells. The micropatterned hydrogel is shown before it is interfaced with a second collagen-based micropatterned hydrogel. This second micropatterned structure also comprises a suspension of endothelial cells and may be nonspecifically bound to a PDMS frame. The first micropatterned structure is supported on a substrate and comprises features that are channels. After interfacing, the micrographs show the resulting multilayer hydrogel structure. This structure comprises two individual sets of endothelial cells, each suspended within their respective hydrogel. These sets of cells are distinguished by different fluorescent markers.

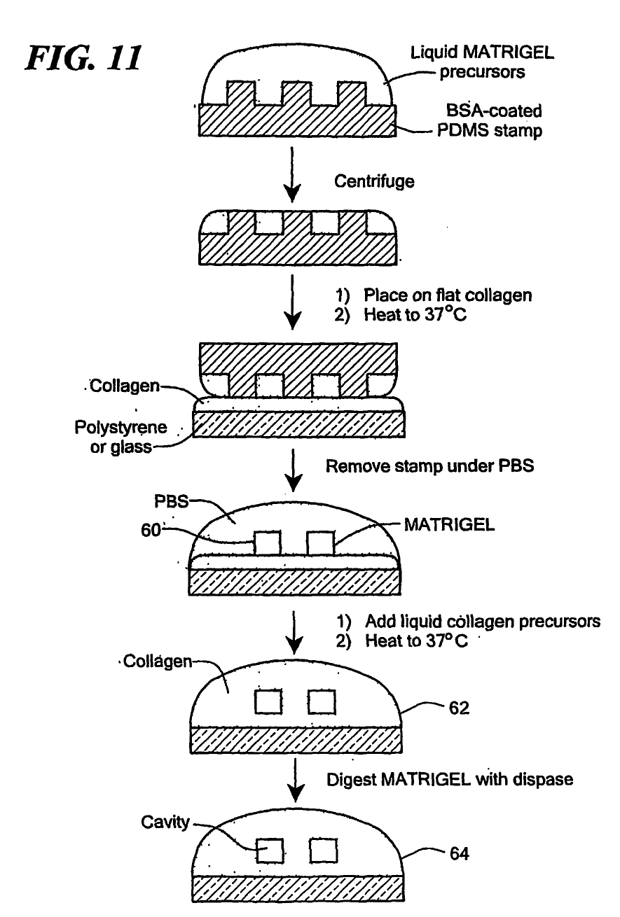

The hydrogel structures of the invention can also be formed or polymerized to encapsulate other hydrogels of the same or different type. An encapsulated hydrogel that is a different type may be perturbed, for example, by an enzyme that specifically digests the encapsulated hydrogel, to form cavities in the encapsulating structure. Alternatively, hydrogels can be heated to perturb the encapsulated hydrogel, such as, for example, gelatin, and form cavities in the encapsulating hydrogel. These cavities can be micropatterned provided that the perturbed hydrogel was micropatterned. A scheme for fabricating a micropatterned hydrogel comprising cavities is represented in FIG. 11. These cavities can include, for example, biological materials, drugs, organics, metals, inorganics, macromolecules, cells or synthetic materials. If the encapsulated materials are sufficiently small, then they will slowly diffuse out of the cavities. If the encapsulated materials are sufficiently large, then they will remain trapped within the cavities.

In this scheme, a MATRIGEL-based structure 60 is formed or polymerized while in contact with a flat collagen-based precursor 62. The collagen is formed or polymerized over the MATRIGEL structure, which will be the perturbed hydrogel. The perturbed hydrogel may be MATRIGEL-based comprising a solution of basement membrane proteins derived from mouse sarcoma. The MATRIGEL-based hydrogel is heated and molded on the collagen-based layer at about 37° C. The collagen-based precursor encapsulates the MATRIGEL-based structure. The collagen-based precursor is slowly added at about 4° C. and heated until about 37° C. Temperature gradients are avoided to prevent deformation of the structures. The MATRIGEL-based hydrogel is digested by an enzyme dispase under mild conditions of about 2 U per ml for one to three hours. The digestion rapidly degrades the MATRIGEL-based hydrogel and minimally digests the collagen-based structure. The resulting hydrogel structure 64 comprises cavities, where the MATRIGEL-based hydrogel was. The parameters identified above are provided merely as examples as any other suitable ranges of the same could be used according to the invention.

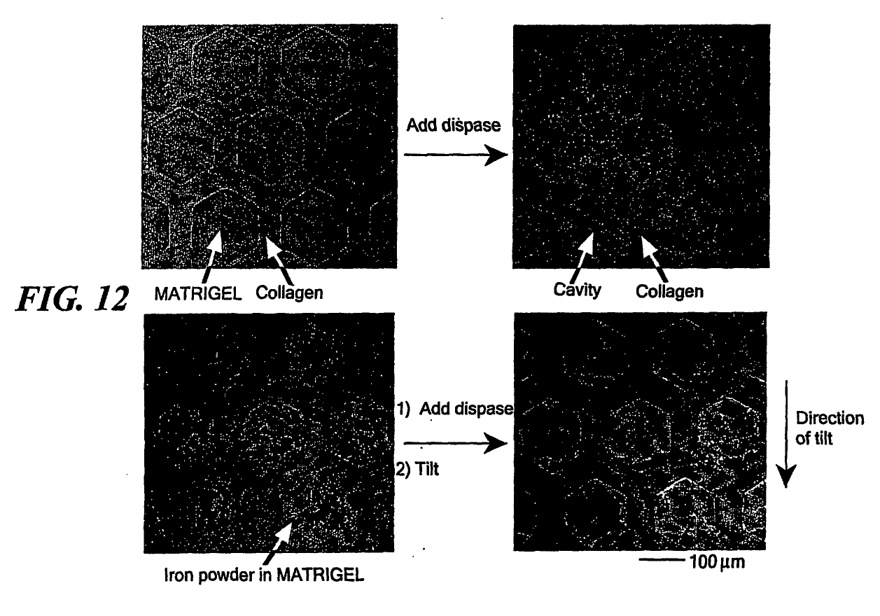

FIG. 12 shows optical micrographs of the digestion scheme. The micrographs show hexagonal structures of MATRIGEL cavities about 50 μm on a side and a thickness of about 50 μm. Iron particles are incorporated and suspended in the cavities with an average particle size of about 5 μm. Prior to digestion, the iron particles are suspended in the MATRIGEL-based hydrogel structure. Following digestion, the iron particles fall due to gravity to the lower boundaries of the hexagon cavities. As the sample is tilted, iron particles aggregate at the corners of the cavities. This observation indicates that the iron particles are no longer suspended in the digested MATRIGEL-based structure and the boundaries of the cavities are identical to the boundaries defined by the micropatterned mold.

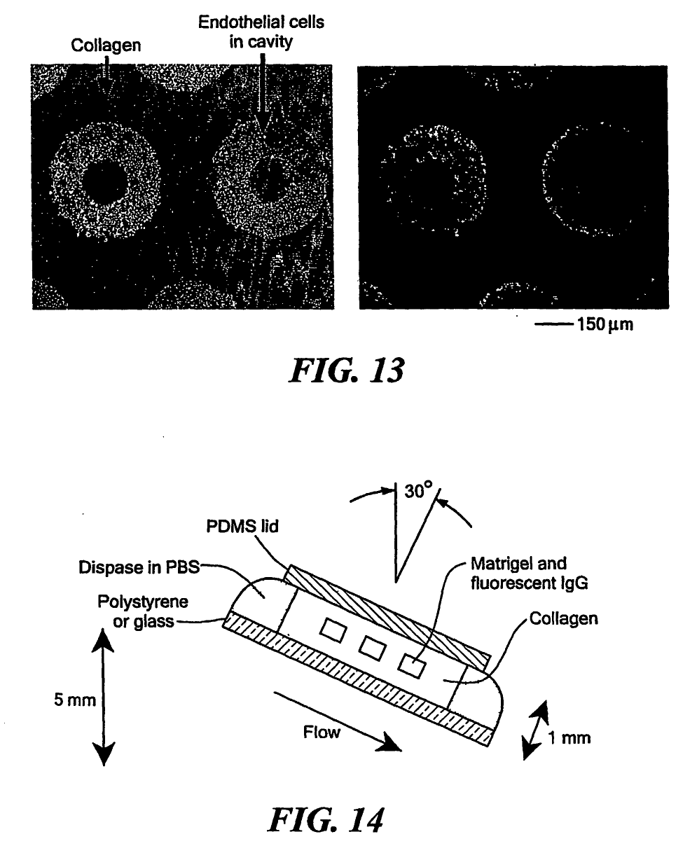

A typical hydrogel structure comprising cavities is also shown in the optical micrographs of FIG. 13 seeded with bovine pulmonary artery endothelial cells. The cavities contain the suspension of endothelial cells at a density of about 10⁸ cells per milliliter. The suspension is mixed with the MATRIGEL precursor prior to formation or polymerization of the MATRIGEL-based hydrogel structures.

One embodiment of the invention comprises fabricating a hydrogel network that can be unsupported or can include a supporting substrate(s). The network is capable of maintaining its integrity for an extended length of time that can include several months. The hydrogel network comprises a plurality of interfaced individually patterned structures of the invention. These networks may be fabricated to comprise two hydrogel structures. The interfaced hydrogels can, for example, be entangled and/or bonded together. Hydrogels in a network may be interfaced as stacked multilayers or configured structures. This embodiment also provides stabilizers, often kosmotropes, and destabilizers, often chaotropes, that can be used to modify the conformation of the hydrogel and facilitate entanglement and/or bonding among the hydrogel structures.

Hydrogel networks of the invention can also comprise a suspension of biological materials, drugs, organics, metals, inorganics, macromolecules, cells and/or synthetic materials. These materials may be suspended in some or all of the individual hydrogels. This hydrogel network can also be formed or polymerized to encapsulate other hydrogels of a different type. The other hydrogels can be perturbed or digested, for example, by an enzyme or suitable perturbant to form cavities in the structure. The cavities can include biological materials, drugs, organics, metals, inorganics, macromolecules, cells or synthetic materials. The type of enzyme used for digestion depends on the hydrogel that is to be perturbed. A MATRIGEL-based hydrogel, for example, can be digested by enzyme dispase. Other suitable enzymes for digesting collagen and agarose include collagenase and agarase, respectively.

The examples herein are presented to illustrate other advantages of the present invention and to assist in preparing the hydrogel structures or networks of the invention. These examples can include or incorporate any of the variations or embodiments of the invention described above. Moreover, the embodiments described above may each include or incorporate the variations of all other embodiments. The following examples are not intended in any way to otherwise limit the scope of the disclosure.

### EXAMPLE I

FIG. 14 shows a scheme for enhancing transport or, flow within the hydrogels by a gravity induced pressure difference. The scheme shows that many materials in a solution may be transported into and out of cavities via diffusion or flow through the encasing hydrogel, although flow is much more rapid than diffusion. The scheme is based on the fabricated hydrogel cavities fabricated as described above. In this example, a pressure difference causes an aqueous solution to flow through the hydrogel and its cavities. The velocity of flow through a sample of 1 mm by 1 cm by 1 cm is about 50 μm per minute. The flow is due to tilting of the hydrogel structure. The tilt is at an angle of about 30°.

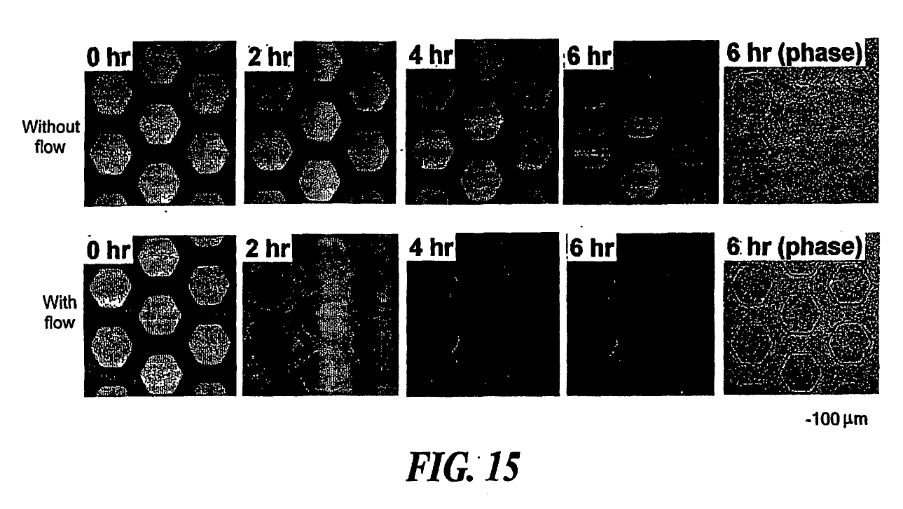

Introduction of a pressure difference can make a solution flow through, for example, the collagen-based hydrogel and the cavities. The flow enhances an exchange of materials between the cavities and the surrounding hydrogel. A fluorescently labeled immunoglobulin IgG of about 150 kDa is incorporated into the MATRIGEL-based hydrogel during formation or polymerization from a precursor, and before digestion of the hydrogel. A fluorescence microscopy method is used to track the release and transport of the antibody out of the cavities after digestion. The decay in fluorescence in the hexagonal cavities is slow without flow. The slow decay is contemplated to be due to nonspecific binding of the antibody with the fibrils in the MATRIGEL-based hydrogel. The binding is sufficient to immobilize a large percentage of the antibody in the hydrogel. The comparisons of inclusion of flow through the network and of non-inclusion of flow are shown in the optical micrographs in FIG. 15.

During flow, the bound protein is transported out of the cavities. With flow for two hours, the intensity of fluorescence decreased by 50 percent. By contrast, without flow fluorescence was decreased by 10 percent. Six hours after the introduction of flow, the cavities lost nearly all of the fluorescence. At all times under flow, the initially uniform distribution of fluorescence of the hexagons develops an outward ring that surrounds the cavities. The ring is polarized by the direction of flow. Although flow enhances the transport of molecules into and out of the cavities, it does not alter the shapes of the cavities. Applications for this structure include, for example, the controlled transport of drugs or growth factor to and from through the cavities, and the release of drugs or growth factor in response to an external signal, such as, for example, the introduction of a specific enzyme. For example, the two-dimensional array of cell-filled cavities described above could be used to study cell behavior due to the introduction of drugs. Also, the two-dimensional array of hydrogels could be used to release an encapsulated drug according to a desired time schedule and geometry to enhance the pharmacokinetic profile of the drug in vivo.

### EXAMPLE II

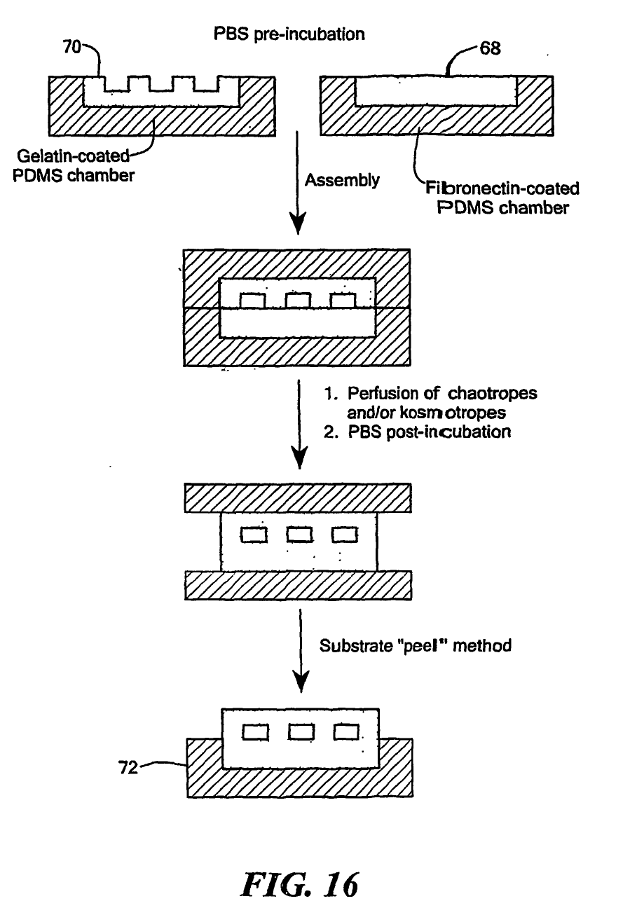

FIG. 16 is a scheme for mechanically entangling and/or chemically bonding a first micropatterned hydrogel 70 and a second hydrogel 68 using a destabilizer as described above. The bonded and/or entangled hydrogels are supported on a substrate 72. The scheme involves treating the surface of the first micropatterned hydrogel with a 0.7 M urea in PBS solution for about five minutes. The second hydrogel surface is treated with 1.7 M urea in PBS solution for about ten minutes. The hydrogels are then interfaced. A PBS solution is flowed through the interfaced hydrogels for about three hours. The adherence strength among the hydrogels can be measured by a suitable substrate peel method.

### EXAMPLE III

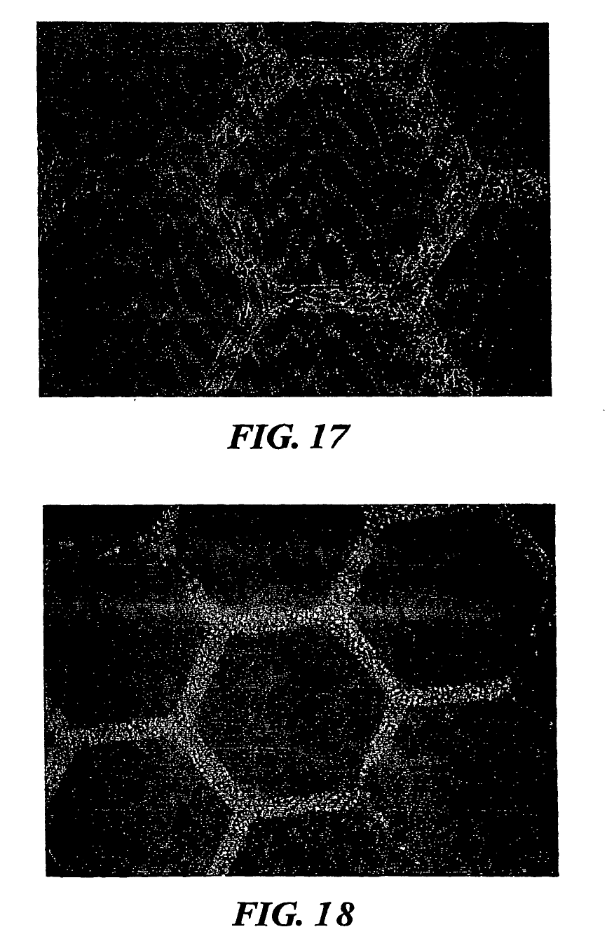

FIGS. 17 and 18 are optical micrographs of different hydrogel networks comprising two micropatterned hydrogel structures. These hydrogels may or may not be mechanically entangled and/or chemically bonded together. The individual micropatterned hydrogel structures can be fabricated by any of the schemes, methods or embodiments described above. The individual hydrogels can also be any suitable type for a particular network or a specific application of that network. For example, the micropatterned hydrogels of these networks can be protein and/or sugar-based. In these networks, the features of the individual hydrogels are aligned to allow fluid flow. The networks received flows of bovine and/or human vascular endothelial cells, which attached to the walls of the network. These cells can be seen in both FIGS. 17 and 18.

The invention provides a convenient method for fabricating the hydrogel structures and networks described above. For example, the invention provides a method for fabricating a micropatterned hydrogel structure by using a treated micropatterned mold. The mold is preferably treated with a release agent as described above. The method is capable of reproducibly transferring the inverse of the micropattern of the mold to a hydrogel structure at a resolution that is less than about 5 μm. A method of the invention generally comprises forming or polymerizing a hydrogel precursor, while the precursor is in contact with the treated surface of the micropatterned mold. The method can also comprise the micropatterned hydrogel being formed or polymerized on a substrate. The micropatterned hydrogel can be separated from the mold, without being collapsed or irreparably deformed, by any suitable process. These processes include, for example, vibration, mechanical separation, application of air bubbles or application of buoyant forces from a fluid acting on the mold.

The method of the invention can be used to embed and/or suspend biological materials, drugs, organics, metals, inorganics, macromolecules, cells or synthetic materials within a hydrogel structure. The present method can also be used to interface a plurality of hydrogel structures. This interfacing may allow the structures to be combined into a multilayer structure or network that can be microfluidic. The interfacing may also comprise chemically bonding, and/or mechanically entangling hydrogels into a more complex structure or network. According to the invention, this bonding and/or entanglement can be aided by destabilizers acting alone, or with a stabilizer to alter the conformation of the polymer array of a hydrogel. The diffusion of one or more hydrogel precursors into a hydrogel structure or network and then forming or polymerizing the precursors can also be used to bond and/or entangle the hydrogels. The method also describes the formation or polymerization of a hydrogel structure that encapsulates other hydrogels that have the same or a different composition. An encapsulated hydrogel that is a different type may be perturbed, for example, by an enzyme that specifically digests the encapsulated hydrogel, to form cavities in the encapsulating structure. These cavities can be micropatterned provided that the perturbed hydrogel was micropatterned.

While the present invention has been described in conjunction with a preferred embodiment, one of ordinary skill in the art, after reading the foregoing specification, will be able to effect various changes, substitutions of equivalents and other alterations to the compositions, methods and/or articles set forth herein. It is therefore intended that the protection granted by Letter Patent hereon be limited only by the definitions contained in the appended claims and equivalents thereof.

1-9. (canceled)

10. A three-dimensional hydrogel structure micropatterned by a mold from which the hydrogel structure has been separated, the hydrogel structure comprising:
a polymer array of a hydrogel, the polymer array comprising a fluid that hydrates the polymer array and a second hydrogel comprising a second polymer array hydrated by a second fluid; and
a micropattern defining a surface of at least one hydrogel, the micropattern corresponding to an inverse micropattern transferred from a mold after separation of the mold from the hydrogels.

11-18. (canceled)

19. A three-dimensional hydrogel structure micropatterned by a mold from which the hydrogel structure has been separated, the hydrogel structure comprising:
a polymer array of a hydrogel, the polymer array comprising a fluid that hydrates the polymer array, wherein the hydrogel is interfaced with a precursor of a second hydrogel comprising a second polymer array hydrated by a second fluid, whereby the precursor of the second hydrogel diffuses into the hydrogel interfaced therewith to adhere the hydrogels as the second hydrogel forms; and
a micropattern defining a surface of at least one hydrogel, the micropattern corresponding to an inverse micropattern transferred from a mold after separation of the mold from the hydrogels.

20. A three-dimensional hydrogel structure micropatterned by a mold from which the hydrogel structure has been separated, the hydrogel structure comprising:
a polymer array of a hydrogel, the polymer array comprising a fluid that hydrates the polymer array, wherein the hydrogel is interfaced with a second hydrogel comprising a second polymer array hydrated by a second fluid, whereby a destabilizer contacting the hydrogel and the second hydrogel conforms at least one of the hydrogels to adhere the interfaced hydrogels together when a concentration of the destabilizer is reduced; and
a micropattern defining a surface of at least one hydrogel, the micropattern corresponding to an inverse micropattern transferred from a mold after separation of the mold from the hydrogels.

21-23. (canceled)

24. A three-dimensional hydrogel structure micropatterned by a mold from which the hydrogel structure has been separated, the hydrogel structure comprising:
a polymer array of a hydrogel, the polymer array comprising a fluid that hydrates the polymer array and a second hydrogel comprising a second polymer array hydrated by a second fluid, whereby precursors of the hydrogel and the second hydrogel were combined to interface the hydrogels as at least one hydrogel is formed; and
a micropattern defining a surface of at least one hydrogel, the micropattern corresponding to an inverse micropattern transferred from a mold after separation of the mold from the hydrogels.

25-30. (canceled)

31. A method for micropatterning a three-dimensional hydrogel structure, the method comprising:
providing a mold, the mold comprising a micropatterned surface;
treating the micropatterned surface of the mold with a release agent;
forming a hydrogel from a precursor, wherein the precursor is in contact with the treated micropatterned surface of the mold while the hydrogel is formed, the hydrogel comprising a fluid that hydrates a polymer array and a second hydrogel comprising a second polymer array hydrated by a second fluid; and
separating the hydrogels from the treated micropatterned surface of the mold such that the mold transfers an inverse of a micropattern to a surface of at least one hydrogel.

32-38. (canceled)

39. A method for micropatterning a three-dimensional hydrogel structure, the method comprising:
providing a mold, the mold comprising a micropatterned surface;
treating the micropatterned surface of the mold with a release agent;
forming a hydrogel from a precursor, wherein the precursor is in contact with the treated micropatterned surface of the mold while the hydrogel is formed, the hydrogel comprising a fluid that hydrates a polymer array;
interfacing the hydrogel with a precursor for a second hydrogel;
diffusing the precursor for the second hydrogel into the hydrogel interfaced therewith;
forming the second hydrogel to adhere the hydrogels; and
separating the hydrogels from the treated micropatterned surface of the mold such that the mold transfers an inverse of a micropattern to a surface of at least one hydrogel.

40. A method for micropatterning a three-dimensional hydrogel structure, the method comprising:
providing a mold, the mold comprising a micropatterned surface;
treating the micropatterned surface of the mold with a release agent;
forming a hydrogel from a precursor, wherein the precursor is in contact with the treated micropatterned surface of the mold while the hydrogel is formed, the hydrogel comprising a fluid that hydrates a polymer array;
interfacing the hydrogel with a second hydrogel;
conforming at least one of the interfaced hydrogels by contacting the hydrogels with a destabilizer;
reducing a concentration of the destabilizer to adhere the hydrogels together; and
separating the hydrogels from the treated micropatterned surface of the mold such that the mold transfers an inverse of a micropattern to a surface of at least one hydrogel.

41-43. (canceled)

44. A method for micropatterning a three-dimensional hydrogel structure, the method comprising:
providing a mold, the mold comprising a micropatterned surface;
treating the micropatterned surface of the mold with a release agent;
combining a precursor for a hydrogel with a precursor for a second hydrogel;
forming the hydrogels from the precursors, wherein the precursors are in contact with the treated micropatterned surface of the mold while the hydrogels are formed; and
separating the hydrogels from the treated micropatterned surface of the mold such that the mold transfers an inverse of a micropattern to a surface of at least one hydrogel.

45-50. (canceled)

51. The three-dimensional hydrogel structure of claim 10, wherein:
the hydrogel comprises a cavity, whereby the cavity is formed by perturbing a portion of the second hydrogel;
the portion of the second hydrogel is perturbed by one of a change in temperature or an enzyme digesting the portion;
the mold substantially comprises silicon materials, poly (dimethylsiloxane) materials, photoresist materials, glass materials, plastic materials, rubber materials, synthetic materials, polymer materials, organic materials or any combination thereof;
the polymer array further comprises materials selected from the group consisting of biological components, organic components, metallic components, cellular components, synthetic components, intact cells, inorganic components and combinations thereof;
the cavity is contacted by flow of a liquid and the liquid comprises materials that are selected from the group consisting of biological components, organic components, metallic components, cellular components, synthetic components, intact cells, inorganic components and combinations thereof and further where the materials of the liquid adhere to a portion of the cavity; and
a portion of at least one hydrogel is interfaced with a substrate.

52. The three-dimensional hydrogel structure of claim 19, wherein:
the hydrogel and second hydrogel form a network;
the network is contacted by flow of a liquid;
the liquid comprises materials that are selected from the group consisting of biological components, organic components, metallic components, cellular components, synthetic components, intact cells, inorganic components and combinations thereof;
the materials of the liquid adhere to a portion of the network; and
a portion of at least one hydrogel is interfaced with a substrate.

53. The three-dimensional hydrogel structure of claim 20, wherein:
the destabilizer is selected from the group consisting of chaotropes, kosmotropes, urea, glucose, glycerol, guanidinium hydrogen chloride and combinations thereof;
the concentration of the destabilizer is reduced when a stabilizer contacts the hydrogels;
the destabilizer and the stabilizer are both selected from the group consisting of chaotropes, kosmotropes, urea, glucose, glycerol, guanidinium hydrogen chloride and combinations thereof;
the hydrogel and second hydrogel form a network;
the network is contacted by flow of a liquid;
the liquid comprises materials that are selected from the group consisting of biological components, organic components, metallic components, cellular components, synthetic components, intact cells, inorganic components and combinations thereof;
the materials of the liquid adhere to a portion of the network; and
a portion of at least one hydrogel is interfaced with a substrate.

54. The three-dimensional hydrogel structure of claim 24, wherein:
the precursor of the hydrogel or second hydrogel comprises a material selected from the group consisting of biological components, organic components, metallic components, cellular components, synthetic components, intact cells, inorganic components and combinations thereof.

55. The method of claim 31, the method further comprising:
forming a cavity within the hydrogel by perturbing a portion of the second hydrogel and the portion of the second hydrogel is perturbed by a change in temperature or an enzyme digesting the portion;
the polymer array further comprises materials selected from the group consisting of biological components, organic components, metallic components, cellular components, synthetic components, intact cells, inorganic components and combinations thereof;
the method further comprising flowing a liquid through the cavity wherein the liquid comprises materials that are selected from the group consisting of biological components, organic components, metallic components, cellular components, synthetic components, intact cells, inorganic components and combinations thereof and wherein the materials of the liquid adhere to a portion of the cavity;
the method further comprising interfacing a portion of at least one hydrogel with a substrate.

56. The method of claim 39 the method further comprising interfacing a portion of at least one hydrogel with a substrate.

57. The method of claim 40, wherein:
the destabilizer is selected from the group consisting of chaotropes, kosmotropes, urea, glucose, glycerol, guanidinium hydrogen chloride and combinations thereof;
the concentration of the destabilizer is reduced when a stabilizer contacts the hydrogels;
the destabilizer and the stabilizer are selected from the group consisting of chaotropes, kosmotropes, urea, glucose, glycerol, guanidinium hydrogen chloride and combinations thereof; and
the hydrogel and second hydrogel form a network;
the network is contacted by flow of a liquid;
the liquid comprises materials that are selected from the group consisting of biological components, organic components, metallic components, cellular components, synthetic components, intact cells, inorganic components and combinations thereof;
the materials of the liquid adhere to a portion of the network; and
a portion of at least one hydrogel is interfaced with a substrate.

58. The method of claim 44, wherein:
the precursor of the hydrogel or second hydrogel comprises a material selected from the group consisting of biological components, organic components, metallic components, cellular components, synthetic components, intact cells, inorganic components and combinations thereof;
the hydrogel and second hydrogel form a network;
the method further comprising contacting the network with flow of a liquid;
the liquid comprises materials that are selected from the group consisting of biological components, organic components, metallic components, cellular components, synthetic components, intact cells, inorganic components and combinations thereof;
the materials of the liquid adhere to a portion of the network; and
the method further comprising interfacing a portion of at least one hydrogel with a substrate.
